(19) United States
(12) Patent Application Publication
(10) Pub. No.: US 2007/0091283 A1
(43) Pub. Date: Apr. 26, 2007

(54) Projection display apparatus

(75) Inventor: Chun-Li Chen, Chu-Nan (TW)

Correspondence Address: RABIN & Berdo, PC, 1101 14TH STREET, NW, SUITE 500, WASHINGTON, DC, 20005, US

(73) Assignee: CORETRONIC CORPORATION, Hsinchu (TW)

(21) Appl. No.: 11/528,667

(22) Filed: Sep. 28, 2006

(30) Foreign Application Priority Data
Oct. 21, 2005 (TW) 094136946

(51) Int. Cl. G03B 21/28

(52) U.S. Cl. 353/99

(57) ABSTRACT

A projection display apparatus and an energy recycling method thereof are provided. The projection display apparatus includes a lamp, a light-to-electricity converter and several optical elements. The light-to-electricity converter receives a reflective light beam from the optical elements and transforms light energy into electricity. By recycling the reflective light energy, the thermal energy of the projection display apparatus is reduced and the power efficiency of the projection display apparatus is improved.

This application claims the benefit of Taiwan application Serial No. 94136946, filed Oct. 21, 2005, the subject matter of which is incorporated herein by reference.

### BACKGROUND OF THE INVENTION

1. Field of the Invention

The invention relates in general to a projection display apparatus, and more particularly to an energy recycling method for projection display apparatus.

2. Description of the Related Art

Referring to FIG. 1, an optical path of a conventional projector is shown. A conventional projector 10 includes a lamp 12, a color wheel 14, an integral rod 16, a reflective mirror 18, a digital micro-mirror device (DMD) 20 and a projection lens 22. The lamp 12 generates a light beam which is sequentially transformed into a red, a green and a blue light beam when passing through the color wheel 14. The red, green and blue light beams are unified after passing through the integral rod 16. The unified light beam is then reflected to the digital micro-mirror device 20 via the reflective mirror 18. The digital micro-mirror device 20 has several micro mirrors (not illustrated). Each micro mirror is switched among an ON-state, a FLAT-state and an OFF-state. As shown in FIG. 2, when the micro mirror is at the ON-state, the light beam, that is the light beam reflected from the reflective mirror 18, is reflected by the micro-mirror device 20 to project an image on a screen (not shown) via the projection lens 22. When the micro mirror is at the FLAT-state or the OFF-state, the light beam, that is the light beam reflected from the reflective mirror 18, is deviated from the projection lens 22 by the micro mirrors.

However, the projector 10 generates many invalid light beams during the process of forming an image, such like the light beam reflected by the color wheel 14 while the red, the green and the blue light beam is sequentially generated by the color wheel 14, the light beam passing through the reflective mirror 18 when the reflective mirror 18 reflects a uniform light beam, and the light beam reflected by the micro mirror when the micro mirror is at the FLAT-state or the OFF-state. The invalid light beams are normally projected inside the projector, raising the temperature of the elements inside the projector and even raising the internal temperature of the projector if the duration of service is too long. If the internal temperature of the projector is too high, the lifespan of the electronic elements inside the projector will be shortened or will result in erroneous actions.

The conventional solution to reduce the internal temperature of the projector is to dispose a fan inside the projector so as to radiate the heat generated inside the projector. Since the fan is powered by electricity, extra electricity will be consumed when the fan is used to radiate the thermal energy generated by invalid light beams.

Thus, how to effectively resolve the thermal energy problem caused by the invalid light beams inside the projector has become an imminent issue to be resolved.

### SUMMARY OF THE INVENTION

It is therefore an object of the invention to provide a projection display apparatus for recycling the light energy to reduce the thermal energy inside the projection display apparatus but increase the power efficiency of the projection display apparatus.

The invention achieves the above-identified object by providing a projection display apparatus including a lamp, a plurality of optical elements and a light-to-electricity converter. The lamp is used for generating a visible light beam. The visible light beam definds and transmits along an optical path. The optical elements are disposed on the optical path for imaging and generating a reflective light beam outside the optical path. The light-to-electricity converter receives the reflective light beam and transforms light energy of the reflective light beam into electricity.

The invention achieves the above-identified object by providing a projection display apparatus including a lamp, a plurality of optical elements and a light-to-electricity converter. The lamp is used for generating a visible light beam. The visible light beam definds and transmits along an optical path. The optical elements are disposed on the optical path for imaging and generating a transmissive light beam outside the optical path. The light-to-electricity converter receives the transmissive light beam and transforms light energy of the transmissive light beam into electricity.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrate an optical path of a conventional projector;

FIG. 2 illustrates an optical path of a digital micro-mirror device in the conventional projector;

FIG. 3 illustrates a projection display apparatus according to a first embodiment of the invention;

FIG. 4 illustrates a power supply system of the projection display apparatus according to the first embodiment of the invention;

FIG. 5 illustrates a projection display apparatus according to a second embodiment of the invention;

FIG. 6 illustrates a projection display apparatus according to a third embodiment of the invention; and

FIG. 7 illustrates a light-to-electricity converter applied in a projection display apparatus according to a preferred embodiment of the invention.

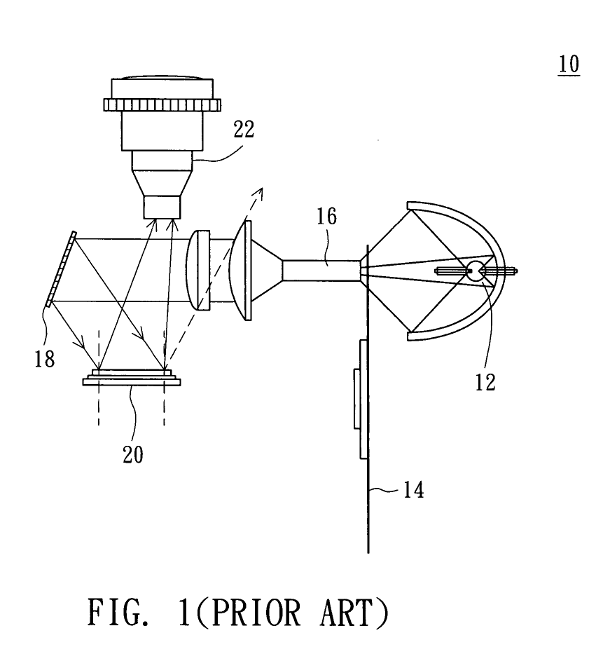

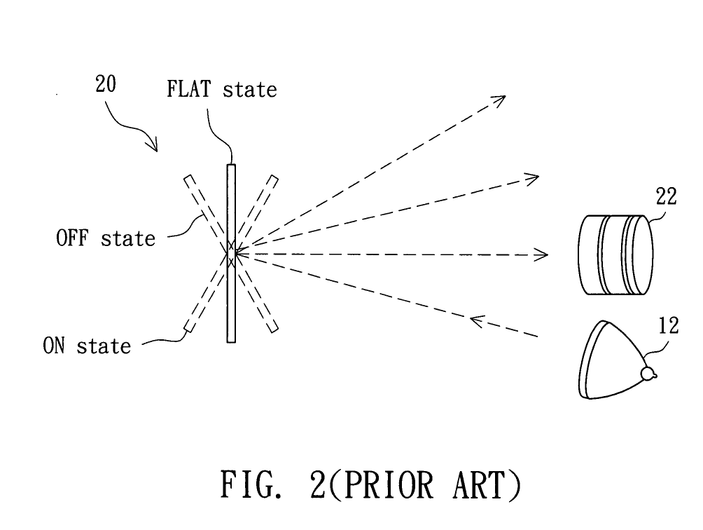

### DETAILED DESCRIPTION OF THE INVENTION

### First Embodiment

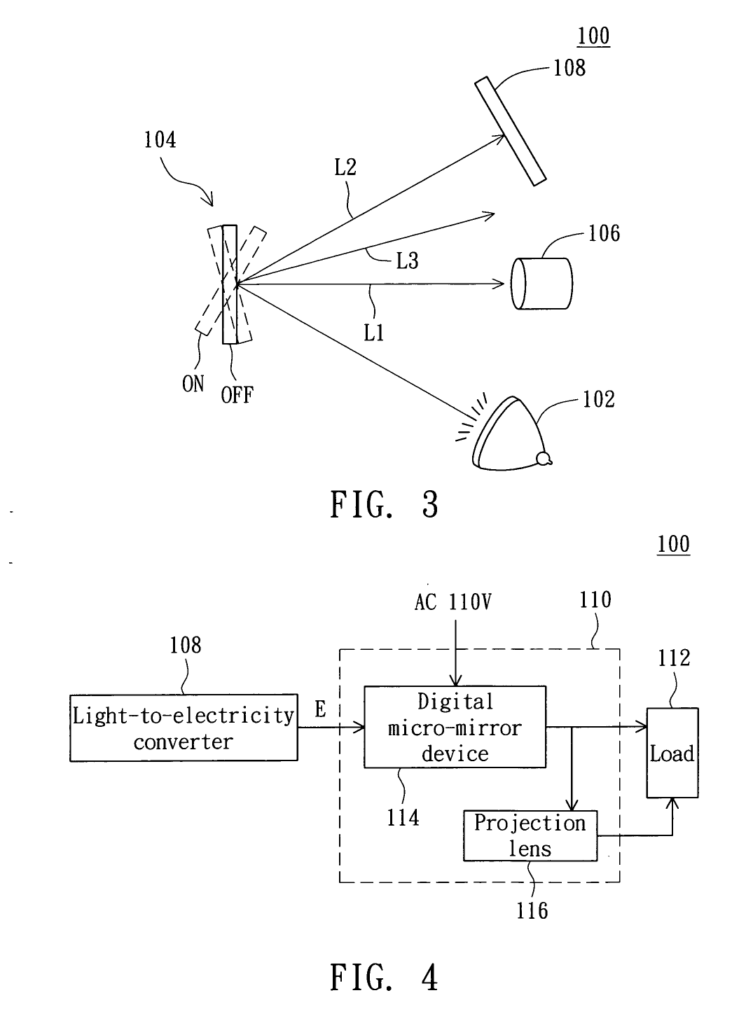

Referring to FIG. 3, a projection display apparatus according to a first embodiment of the invention is shown. A projection display apparatus 100 includes a lamp 102, a light-to-electricity converter 108 and a plurality of optical elements. The optical elements include a digital micro-mirror device 104 and a projection lens 106. The lamp 102 is used for providing the projection lens 106 with necessary light source for forming an image. The light-to-electricity converter 108, e.g. a solar panel, is used for transforming the light energy into electricity E. The digital micro-mirror device 104 is composed of a plurality of micro mirrors (not shown). Each micro mirror is switched among a first state (ON-state), a second state (OFF-state) and a third state (FLAT-state) according to the controlling signal received by the projection lens. When the digital micro-mirror device 104 is at the first state, the digital micro-mirror device 104 reflects the light beam generated by the lamp 102 to the projection lens 106 along the first optical path L1 to be displayed as a bright spot. When the digital micro-mirror device 104 is at the second or the third state, the digital micro-mirror device 104 reflects the light beam generated by the lamp 102 to be deviated from the projection lens 106 along the second optical path L2 or the third optical path L3 respectively to be displayed as a dark spot. The light-to-electricity converter 108 is disposed on the second optical path L2.

When the digital micro-mirror device 104 operates, light beams keep being generated on the second optical path L2 along with the formation of an image. However, the light beam on the second optical path L2 is not used for imaging, but is projected on one internal side of the projection display apparatus 100 and causes the internal temperature of the projection display apparatus 100 to rise up. By disposing the light-to-electricity converter 108 on the second optical path L2, the light energy of the light beam not used for imaging is transformed into electricity E.

Referring to FIG. 4, a power supply system of the projection display apparatus according to the first embodiment of the invention is shown. The projection display apparatus 100 further includes a power supply system 110 and a load 112. The load 112 is the element of the projection display apparatus 100 that needs electricity, e.g. a radiating fan, a liquid crystal screen on a control panel, a lamp 102, a USB interface or an LED lamp. The power supply system 110 receives the electricity E generated by the light-to-electricity converter 108 and provides the electricity E to the load 112.

The power supply system 110 further includes a system controlling circuit 114 and an electricity storage device 116, e.g. a battery. The system controlling circuit 114 is used for managing the power source of the projection display apparatus 100. For example, the system controlling circuit 114 receives and transforms a power supply of AC110V into several direct current voltages and then provides direct current voltages to the load 112 or stores the electricity in the electricity storage device 116. For example, the system controlling circuit 114 stores the electricity E generated by the light-to-electricity converter 108 in the electricity storage device 116, after the projection display apparatus 100 is switched off, the electricity stored in the electricity storage device 116 is used for driving the fan to continue heat radiation without relying on the power supply of AC110 to supply necessary electricity.

The light energy on the second optical path L2 is one of the main factors of rising the internal temperature of the projection display apparatus 100. By disposing the light-to-electricity converter 108 on the second optical path L2 of the digital micro-mirror device 104 to transform the light energy generated on the second optical path L2 into electricity E, the present embodiment of the invention largely reduces the thermal energy generated by the light beam and prevents the internal electronic elements of the projector from being damaged by or incurring errors due to the high temperature. The electricity E generated by the light-to-electricity converter 108 is used to power the fan or the load 112, hence increasing power efficiency. Thus, the present invention solves the problem of consuming more electricity when reducing the thermal energy generated by the light energy in the conventional practice. Besides, in terms of structural design, the present embodiment of the invention achieves the objects of recycling energy and saving cost simply by disposing the light-to-electricity converter 108 on the second optical path L2 without changing the original structure of the projection display apparatus 100.

### Second Embodiment

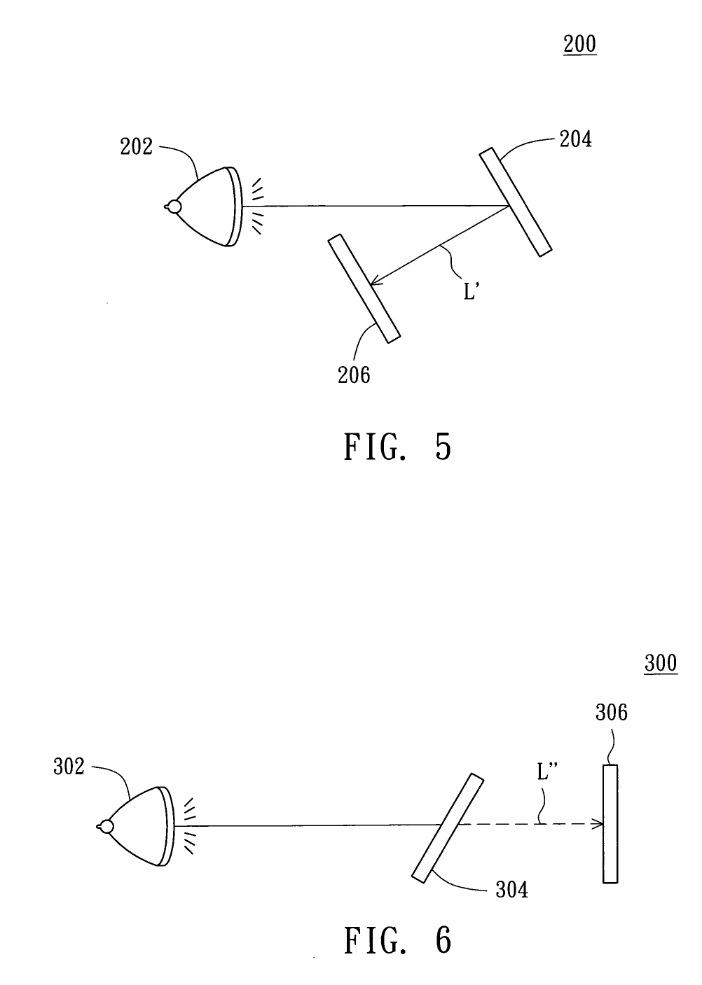

The present embodiment of the invention differs with the first embodiment in the position of the light-to-electricity converter. Referring to FIG. 5, a projection display apparatus according to a second embodiment of the invention is shown. The projection display apparatus 200 includes a lamp 202, a light-to-electricity converter 206 and several optical elements. The optical element further includes a color wheel 204. The color wheel 204 is disposed in front of the lamp 202 and tilts to an angle. The light-to-electricity converter 206 is disposed on the optical path L′ of the reflective light beam not passing through the color wheel 204.

The lamp 202 is used for generating a white light beam. The color wheel 204 is used for filtering the white light beam generated by the lamp 202 into a red, green or blue incident light beam. The incident light beams of three colors form an image after passing through the digital micro-mirror device and the projection lens. By tilting the color wheel 204 to an angle to reflect the reflective light beam not passing through the color wheel 204 to the light-to-electricity converter 206, the present embodiment of the invention uses the light-to-electricity converter 206 to transform the light energy of the reflective light beam into electricity E′. That the light energy is not used for imaging is transformed into electricity E′ for the projection display apparatus 200. For example, according to the disclosure of the power supply system 110 in the first embodiment, the power efficiency of the projection display apparatus 200 is increased, and the thermal energy generated by the light energy is reduced. In terms of the structural design, the present embodiment of the invention only needs to tilt the color wheel 204 having an angle with the optical path for enabling the light-to-electricity converter 206 to receive the reflective light beam not passing through the color wheel 204. Thus, the object of recycling energy and saving cost is achieved without using complicated circuits or structural design.

In the present embodiment of the invention, the color wheel 204 is not restricted to be tilting to any particular angle. Any angle enabling the light-to-electricity converter 206 to receive the light beam reflected from the color wheel 204 is done.

### Third Embodiment

The present embodiment of the invention differs with the previous two embodiments in the position of the light-to-electricity converter. Referring to FIG. 6, a projection display apparatus according to a third embodiment of the invention is shown. The projection display apparatus 300 includes a lamp 302, a light-to-electricity converter 306 and several optical elements. The optical elements include at least a reflective mirror 304. The reflective mirror 304 is disposed in front of the lamp 302 with a tilting angle, and is positioned on the optical path that the light beam generated by the lamp 302 passes through the optical elements to form an image. The light-to-electricity converter 306 is disposed on the optical path L″ of the transmissive light beam passing through the reflective mirror 304.

Since part of the light beam, which is generated as the reflective mirror 304 reflecting the light beam generated by the lamp 302, passes through the reflective mirror 304 and is projected on one lateral side inside the projection display apparatus 300 to cause the internal temperature of the projection display apparatus 300 to rise up. By disposing the light-to-electricity converter 306 on the optical path L″, the transmissive light beam passing through the reflective mirror 304 is received and the light energy of the transmissive light beam is transformed it into electricity E″. As disclosed above, by transforming the light energy not used for imaging into electricity E″ for the projection display apparatus 300 to use, the power efficiency of the projection display apparatus 300 is improved and the thermal energy generated by the light energy is reduced.

In the present embodiment of the invention, the reflective mirror 304 is neither limited to be tilting to any particular angle nor limited to any particular type. Any reflective mirror 304 enabling the light-to-electricity converter 308 to receive the transmissive light beam passing through the reflective mirror 304 is disposed. Thus, the object of recycling energy is achieved by a simple and cost saving design without having to change the original design of the optical path of the projection display apparatus 300 or use complicated circuits or structural design.

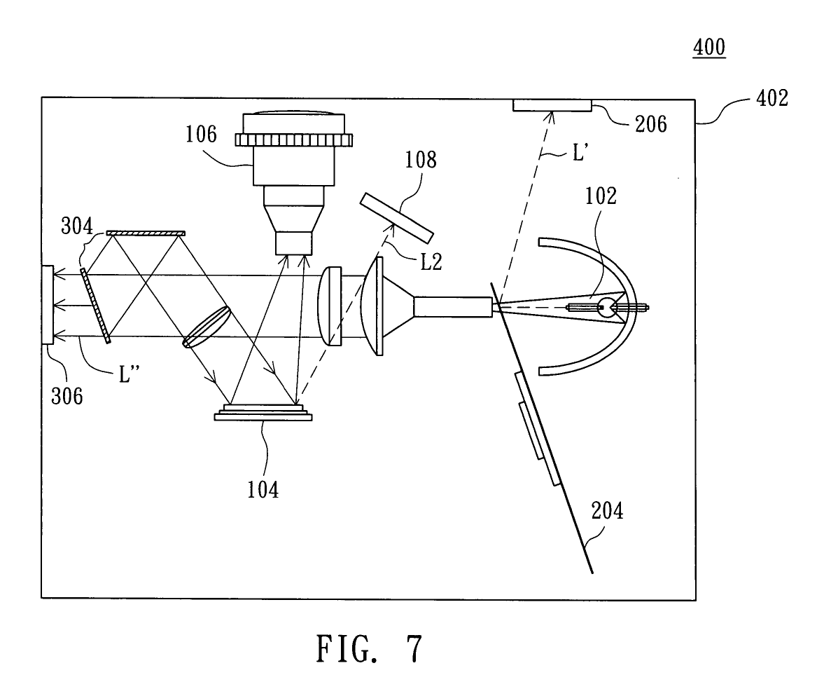

The above three embodiments do not restrict the type nor restrict the position of the light-to-electricity converter 108. Any design enabling the light energy to be transformed into electricity is done. It does not matter whatever source of the light energy to be transformed into electricity comes from. Any source of the light beam that comes from a visible light beam and is not used for imaging or guided to the projection lens is operable. The design of the above three embodiments can be applied to the same projection display apparatus. Referring to FIG. 7, a light-to-electricity converter of the invention applied in a projection display apparatus is shown. The projection display apparatus 400 includes a housing 402, several light-to-electricity converters 108, 206, 306 and several optical elements disposed inside the housing 402. The optical elements include the digital micro-mirror device 104, the color wheel 204 and the reflective mirror 304. The light-to-electricity converter 108 is used for recycling the light energy of the reflective light beam from the digital micro-mirror device 104 when the digital micro-mirror device 104 is at the second or the third state. The light-to-electricity converter 206 is used to recycle the light energy of the reflective light beam from the color wheel 204. The light-to-electricity converter 306 is used for recycling the light energy of the transmissive light beam passing through the reflective mirror 304. The power supply system 110 (not illustrated in FIG. 7) is used to receive the electricity generated by the light-to-electricity converters 108, 206 and 306 to power the load 112.

The projection display apparatus capable of recycling energy disclosed in the above embodiments of the invention transforms the light energy of the light beam not used for imaging into electricity to power the electronic elements inside the projection display apparatus and increase the power efficiency of the projection display apparatus. As part of the light energy is transformed into electricity, the internal temperature of the projector is reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projection display apparatus, comprising:
a lamp used for generating a light beam, the light beam defining and transmitting along an optical path;
a plurality of optical elements disposed on the optical path for imaging, and generating at least a reflective light beam outside the optical path; and
a light-to-electricity converter for receiving the reflective light beam and transforming light energy of the reflective light beam into an electricity.

2. The projection display apparatus according to claim 1, wherein the light-to-electricity converter is disposed on an optical path of the reflective light beam.

3. The projection display apparatus according to claim 1, further comprising a power supply system for receiving the electricity and providing the projection display apparatus with necessary power for operation.

4. The projection display apparatus according to claim 1, wherein the light-to-electricity converter is a solar panel.

5. The projection display apparatus according to claim 1, wherein the optical elements comprise:
a projection lens; and
a digital micro-mirror device for reflecting the light beam to form at least a first optical path and a second optical path, wherein the projection lens is disposed on the first optical path, and the light-to-electricity converter is disposed on the second optical path to receive the reflective light beam reflected from the digital micro-mirror device.

6. The projection display apparatus according to claim 1, wherein the optical elements comprise a color wheel disposed in front of the lamp, and the color wheel forms a tilting angle with the optical path, and the light-to-electricity converter receives the reflective light beam reflected from the color wheel.

7. A projection display apparatus, comprising:
a lamp used for generating a light beam, the light beam defining and transmitting along an optical path;
a plurality of optical elements disposed on the optical path for imaging, and generating at least a transmissive light beam outside the optical path; and
a light-to-electricity converter for receiving the transmissive light beam and transforming light energy of the transmissive light beam into an electricity.

8. The projection display apparatus according to claim 7, wherein the light-to-electricity converter is disposed on an optical path of the transmissive light beam.

9. The projection display apparatus according to claim 7, further comprising a power supply system for receiving the electricity and providing the projection display apparatus with necessary power for operation.

10. The projection display apparatus according to claim 7, wherein the light-to-electricity converter is a solar panel.

11. The projection display apparatus according to claim 7, wherein the optical elements comprise a projection lens and a digital micro-mirror device for imaging.

12. The projection display apparatus according to claim 7, wherein the optical elements comprise a reflective mirror, and the light-to-electricity converter is used for receiving the transmissive light beam passed through the reflective mirror.
